(19) United States
(12) Patent Application Publication
(10) Pub. No.: US 2008/0121331 A1
(43) Pub. Date: May 29, 2008

(54) Method of Glass-to-Glass Adhesion Using Locators

(76) Inventor: Peter Beasley, MerMaid Waters (AU)

Correspondence Address: GREENBERG & LIEBERMAN, LLC, 2141 WISCONSIN AVE, N.W., SUITE C-2, WASHINGTON, DC, 20007, US

(21) Appl. No.: 11/564,217

(22) Filed: Nov. 28, 2006

(51) Int. Cl. B44C 3/12

(52) U.S. Cl. 156/63

(57) ABSTRACT

A system for applying glass bevels to a mirror, glass, or other clear structure in a vertical or horizontal position using reusable and non reusable locators. The present invention uses an adhesive that cures crystal clear upon the application of visible or UV light. The bevels used feature fully polished edges and permit reflective gaps to be maintained in between the bevels.

### FIELD OF INVENTION

The relevant field of the present invention is glass-to-glass adhesion. Specifically, the present invention relates to a method of adhering beveled glass to another piece of glass using the Exposed Edge Bevel Technique (EEBT). Additionally, the present invention utilizes the precision and reliability of locator-work in applying the EEBT to adhere glass-to-glass in a vertical or horizontal way.

### BACKGROUND OF THE INVENTION

Glass and mirrors are integral parts of nearly every home, apartment, or dwelling. While glass can afford excellent views, often, it can be very plain. To combat this, people may decorate portions of glass and mirrors in order to break up the large, empty expanse. Such coverings have included photos, curtains, and additional glass cut into a decorative pattern and affixed upon the original structure.

U.S. Pat. No. 5,045,370 issued to Raum on Sep. 3, 1991, is a window pane which possesses numerous beveled glass plates that are arranged into a decorative cluster. Unlike the present invention, metal channels are needed in order to hold the window planes in place. Unlike the present invention, the beveled pieces cannot be merely affixed onto the glass surface with only adhesive.

U.S. Pat. No. 5,098,760 issued to Fletcher on Mar. 24, 1992, is a decorative, leaded glass panel affixed to a glass pane. Unlike the present invention, metal channels are affixed to the glass pieces and ultraviolet light is necessary in order to cure the adhesive.

U.S. Design Pat. No. 313,855 issued to Hall on Jan. 15, 1991, is a decorative glass panel comprising of numerous glass pieces arranged into a decorative panel. Unlike the present invention, the glass pieces must be held in place by a metal frame and cannot be simply attached to an existing surface using adhesive. Also, unlike the present invention, the glass pieces are not beveled.

International Patent Number WO 96/34302 issued to Futhey and Sundet on Oct. 31, 1996 is a decorative design used to simulate beveled glass. Unlike the present invention, it uses a double sided tape or adhesive that needs ultraviolet light to cure. Unlike the present invention, double sided tape is less then desirable because it is easily visible. Also unlike the present invention, it uses metal pieces to cover its edges.

International Patent Number WO 96/34771 issued to Sundet on Nov. 7, 1996, is a simulated beveled glass design that uses polymer pieces to create a design. Unlike the present invention, it does not use actual glass.

It is desirable to have a method for attaching beveled glass to mirrors and glass that does not need the metal frames so common in conventional beveled glass applications. Further it is desirable to have a method for attaching beveled glass to mirrors and glass so that the beveled glass edges can be seen and appreciated. Also, it is desirable to have a method for attaching beveled glass to mirrors and glass that permits exposed edges on the bevels so that if they are polished the polished condition can be seen by the user. Additionally, it is desirable to have a method for attaching beveled glass to glass without the need for having access to both the front and back sides of the glass. In other words, it is desirable to have a method for attaching beveled glass to glass wherein the user only needs to have access to one side of the glass so that the bevels can be placed. Traditionally, a pattern is attached to the back side of glass, and the bevels are placed on the front side of glass according to the pattern viewed through the glass. So, it is desirable to have a method for attaching beveled glass to glass when only one side of the glass is accessible—as window in a high rise condo that does not open. In such a circumstance, it would be nearly impossible to attach a pattern to the back side of the glass because the window is so high off the ground. Further, it is desirable to have a method for attaching beveled glass to mirrors and glass so that there is a physical guide for the installer so that beveled glass can form true right angles and line up properly.

Therefore, there is a need for a simulated bevel glass system that utilizes actual glass bevels and easy to use and safe adhesives. This beveled glass system must also be applicable without the need for metal pieces to hide the edge of the bevels.

### SUMMARY OF THE INVENTION

Affixing decorative glass to a larger piece of glass can produce attractive and economical home decorating solutions. However, this process is not nearly as easy as one makes it sound. In fact, there are numerous complications that can serve to limit the effectiveness of an implementation of the decorative solution. First, one must ensure that the glass being affixed to the original structure is attractive in appearance. Second, one must ensure that the pattern being affixed is properly spaced. Finally, one must ensure that the adhesive used is capable of adequately holding the glass in place while not compromising the aesthetics of the pattern.

First, most glass that is affixed to mirrors and other glass panels are manufactured in a way such that its front and back surfaces are polished, but the edges are not. Thus, it has been necessary to secure such glass in place with a lead frame in order to hide the ugly unpolished edges. However, the use of a lead frame destroys the clarity and transparency of the original window. In addition, the frame prevents the potentially attractive reflections that could emanate from the edges of the glass. Thus, there is a need for decorative a method of using glass that is shiny, transparent, and polished on all sides, including the edges—and the present invention does just this. The present invention allows all sides of beveled glass to be appreciated—even the polished edges—because edges (whether polished or not) are not obscured when beveled glass is installed per the present invention. For purposes of the present invention, a glass bevel is a piece of glass most typically, but not always, five to six mm thick with sloping sides that slope down to most typically, but not always, a one to two mm thickness. The edges are then polished. Bevels can be in the form of a cluster of glass bevels to make a pattern or individual geometric shapes.

Second, in order for a decorative design to be appealing, it must be properly spaced as originally intended. When affixing glass to glass, it can be difficult to simply get the pattern properly aligned by eye, particularly for a person with no prior experience in the discipline. In addition, with the adhesive temporarily acting as a lubricant, the glass may slide out of its intended position. Patterns have been used to help with the placement of glass. However, these patterns have all had some manner of shortcoming. Much like a dress patterns, some patterns are simply used to trace the pattern onto the glass, and then the marks on the glass serve as guides. These marks can unfortunately easily be dissolved during beveled glass application because adhesive tends to act as a solvent. Thus, the installer of the beveled glass suddenly finds the marks missing in the middle of a beveled glass application. Other patterns are placed on the back side of a window so that they can be followed as beveled glass is placed on the front side of the glass. For mirrors it is reasonably impossible to place a pattern on the back side of the mirror because the very nature of a mirror means that you would not see the pattern during beveled glass application on the front side of the mirror. Whatever pattern is used though, there is no means of keeping the beveled glass in place until the adhesive has dried—in other words, there is no physical element to the pattern—the pattern is purely a visual guide so the beveled glass can still shift before drying. Some patterns are simply one time use devices that become destroyed upon removal. Constantly having to purchase new patterns can become expensive. Therefore, the present provides a method for installing beveled glass that provides locators that not only remain in place while the adhesive dries, but also that preferably can be reused. The locators of the present invention accurately locate the glass bevels onto the glass or mirror surface. Openings are made in the bevel locator approximately 2 mm bigger then the glass piece that is to be inserted into it. This allows movement of the bevels from side to side so to allow adhesive and air to flow out to the sides from underneath the bevel. When glass bevels are cured, then the locator is removed.

Finally, in order for the decorative design to succeed, a strong adhesive must be used that will not interfere with the aesthetics of the design. This means that the adhesive must be able to expand and contract with the glass as it heats up and cools down. The adhesive must be long lasting and durable. In addition, in order to maintain the aesthetic appeal of the design, the adhesive must be crystal clear. Up until the present, this has meant that most adhesives that are used to bond glass to glass require solely ultraviolet (UV) light in order to properly adhere. UV light promotes strong and permanent glass-to-glass bonding without the need for a heat source, and can be essentially transparent. One major disadvantage of using UV adhesives is the danger to humans that UV radiation poses. Just as spending too much time in the sun can cause cancer, exposure to UV radiation from UV lamps can be carcinogenic as well. UV lamps are especially hazardous for professionals and artisans who repeatedly use them in their work, and thereby expose themselves to dangerous amounts of UV radiation. In addition, UV lamps require a good deal of power and can be expensive to purchase. As a result, any glass to glass bonding project that requires the use of UV light may be cost prohibitive for the do-it-yourselfer to tackle alone. Further, UV based adhesives have generally proven incapable of expanding and contracting with glass as it changes in temperature. This lack of flexibility can cause thermal fracture, therefore smashing or cracking the glass structure. Therefore, the present invention provides a method of beveled glass to mirror or glass adhesion that does not rely on harmful and expensive UV radiation to cure. Moreover, the present invention is a method of beveled glass to mirror or glass adhesion that provides expansion and contraction with glass as the temperature changes, to prevent thermal fracture.

### BRIEF DESCRIPTION OF THE DRAWINGS

FIG. 1 is a flow chart of the steps of the present invention.

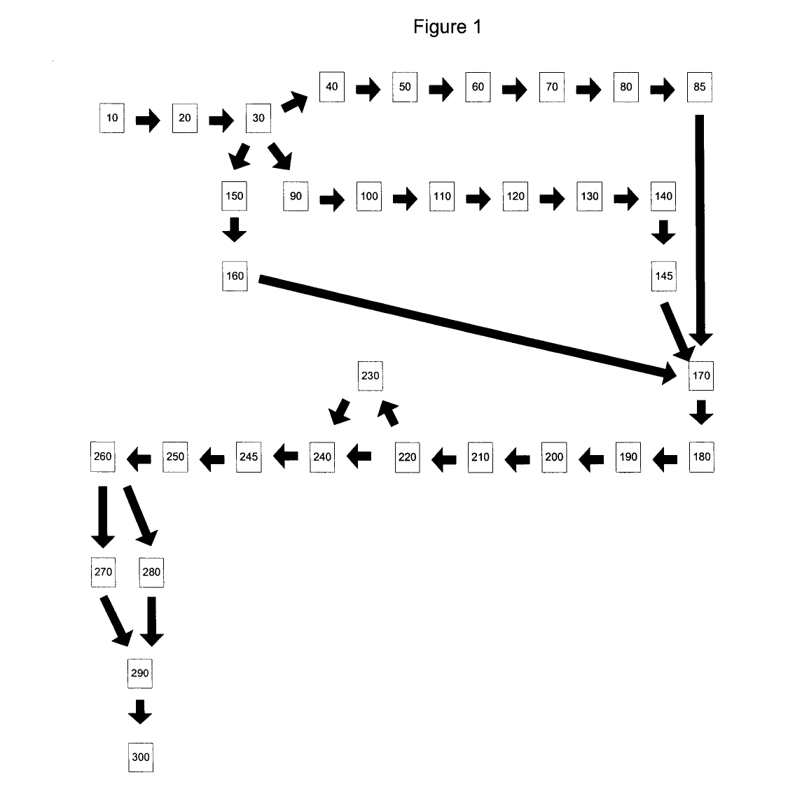

FIG. 2 shows bevels that can be used with the present invention.

FIG. 3 shows a locator placed into position, locating the destination for bevels to be placed according to the present invention.

FIG. 4 shows bevels being placed into opening of a locator according to the present invention.

FIG. 5 shows a locator being removed once bevels have been placed according to the present invention.

FIG. 6 shows bevels in there intended design according to the present invention.

### DETAILED DESCRIPTION OF THE PREFERRED EMBODIMENT(S)

The present invention a system by which one can create a decorative design using beveled glass upon a glass surface or mirror. This system has three major steps: 1) the construction of the glass, 2) the layout of the design with a locator, either on a vertical or horizontal glass/mirror surface, and 3) the affixing of the design to the surface using a light sensitive adhesive.

In the preferred embodiment of the present invention, the glass is constructed using the Exposed Edge Bevel Technique (EEBT) (10). Traditional beveled edges are not polished, and are therefore aesthetically unattractive. Therefore, traditionally beveled edges have needed to be covered adhesive lead or lead cams. This requires that neighboring pieces of glass be placed in contact with one another. Because of this, spaced and open designs are impossible to implement. The EEBT polishes the exposed bevels of a plate of glass in order to make them aesthetically appealing for viewing when affixed to glass or a mirror—the polishing is done via conventional methods. The EEBT permits spaces between the glass and eliminates the need for unattractive lead coverings, thus making the design flow more smoothly with just the glass members.

The layout of the glass is a multi step process. The first step is the cleaning of the glass (20). This glass must be cleaned with a glass cleaner and then wiped with a low lint tissue. Failure to properly clean the surfaces will result in improper bonding and foreign bodies in the interface between the bevel pieces and the glass surface. Next, the locators must be applied (30). In the preferred embodiment of the design, the vinyl locators are remotely like a stencil used for illustrations, and can be applied using two different methods: wet or dry. The reusable locators may only be applied in one manner. Locators can be applied to a vertical or horizontal surface.

When applying the vinyl locators using the wet method, the locator must first be separated from the white, waxy sheet (40). Both the glass and the locator must now be wet with water (50). The locator is then affixed to the mirror and a credit card, or similarly shaped object must be used to push the water out of the gap between the locator and the glass piece (60). In the preferred embodiment, this would mean that one would start near the center of the locator, and using the narrow edge of the credit card against the back of the locator, move in a sweeping motion with the card towards the edges of the locator. Once this process has been completed along the entire locator, a pause must be taken until the vinyl is completely dry, which could take up to several hours (70). Once the vinyl has dried, the top, thin layer of paper must be separated from the vinyl (which remains on the glass) (80). If during the removal process the vinyl begins to separate from the mirror, the process should be paused and the backing and vinyl should be pressed back into the mirror, as this is an indication that the vinyl has not had adequate time to dry (85).

When applying a vinyl locator using the dry method, the locator must first be secured to vertical or horizontal glass structures in the desired location with tape along each edge (90). In the preferred embodiment, one strip of tape would be placed across the center of the locator and the tape along the edges would be removed (100). One half of the locator would be lifted up and the white, waxy sheet would be removed from that half (110). The locator would then be lowered onto the mirror and a credit card or similar device should be used in a sweeping motion away from the center of the locator towards the edge that has had the backing removed (120). The same process should be completed on the other half of the locator upon which the backing remained affixed from the prior step (130). Once the locator is affixed to the glass surface, the top, thin layer of paper should be removed from the vinyl locator material by people the paper away from the mirror (140). If the vinyl begins to come off the mirror, it should be gently reapplied with a plastic credit card or similar device (145).

When applying the bevel pieces with the reusable locator, in the preferred embodiment, one first cleans the locator and glass surface in order to remove any contamination (150). The locator must then be secured in place (160). In the preferred embodiment, the locator is taped in place. The procedure for bonding the bevels to the glass, as discussed below, must then be followed. After the bevels have been bonded in place, the locator may be removed and carefully cleaned with soapy water and a white scourer. Methylated spirits should not be used as the will cause contamination of the locator.

Once the locator has been properly applied to the glass, the process of affixing the beveled pieces to the glass may begin. In order to bond the beveled pieces to the glass, a special adhesive, Nano470 Glass Adhesive™ must be used in the preferred embodiment of the invention. Nano470 Glass Adhesive™ is the preferred adhesive for several reasons. First, Nano470 Glass Adhesive™ is preferred because it is easier and safer to use then most adhesives. Nano470 Glass Adhesive™ does not require the use of UV light in the curing process, unlike many adhesives that are used to bond glass to glass. The use of UV light is dangerous because excessive exposure to UV light is known to cause cancer. In addition, UV light sources can be difficult to procure and are often expensive. As opposed to UV light, Nano470 Glass Adhesive™ needs only visible light but has the option of UV light if desired, to cure properly. This light can be supplied from a variety of household sources, including an ordinary desk lamp. Nano470 Glass Adhesive™ forms the most effective bonds when it is illuminated with light of a wavelength of 470 nanometers. This wavelength light is in the blue part of the spectrum. While Nano470 Glass Adhesive™ will cure with the use of regular white light out of a desk lamp, in the preferred embodiment of the invention, a blue decorative bulb is inserted into the light source and used for the curing process. Blue decorative bulbs are inexpensive and readily attainable. Unlike UV light, blue light poses no known health risks and is safe to use. In addition, blue light bulbs are cheaper and more readily attainable the UV producing light sources.

Nano470 Glass Adhesive™ has other desirable characteristics that make it the preferred adhesive in the present invention. When bonding glass to glass, it is important that the adhesive shrinkage is minimized. If the adhesive were to shrink, it would leave visible gaps between the two glass pieces around the edges, that would deter from the overall beauty of the design. Nano470 Glass Adhesive™ shrinkage is insignificant compared to UV adhesives. This is because Nano470 Glass Adhesive™ cures with visible light. This is a lower energy process then curing with UV light. Because of the lower energy light, Nano470 Glass Adhesive™ contraction is minimized, unlike most adhesives that cure with UV light. In addition, for the same reason and in order to eliminate thermal fracture (which would break the glass structure), the adhesive must be capable of expanding and contracting with the glass as it heats up and expand, and cools and contracts. Nano470 Glass Adhesive™ is capable of expanding and contracting as the glass expands and contracts. In addition, Nano470 Glass Adhesive™ is the preferred adhesive because it has a low viscosity. Low viscosity makes any extra Nano470 Glass Adhesive™ (that has not yet dried) easy to remove from the work surface. Petrochemicals are not needed to clean up Nano470 Glass Adhesive™ residue. Simply a scouring pad and a mild detergent are needed in order to clean up Nano470 Glass Adhesive™ residue. This saves both time and the cost of purchasing expensive solvents. Also, Nano470 Glass Adhesive™ is the preferred adhesive because it has very little odor. The bonding of glass to glass often occurs in confined spaces. Working with a low odor adhesive makes this process much more comfortable for the worker then working with an adhesive with a strong odor. Unlike most other adhesives, Nano470 Glass Adhesive™ is a low irritant. Therefore, accidental contact with the skin will not be nearly as harmful as it would with other adhesives. This creates a safer environment for persons using the glass to glass bonding technique to work in. Finally, Nano470 Glass Adhesive™ dries completely crystal clear, which is of the utmost necessity for the glass to glass bonding technique. For these reasons, Nano470 Glass Adhesive™ is the preferred adhesive in the present invention. However, any conventional adhesive can be used, preferably one that dries with visible light. Any conventional adhesive with some or all of the properties of Nano470 Glass Adhesive™ is preferred.

The glass bevels may be applied to a glass surface that is oriented in either of two planes: vertical or horizontal. This is very important because in the past, mirrors and glass pieces had to be removed from their structural positions at great expense and laid horizontally. This removal could cause the glass or mirror to break and expensive due to extra specialized labor involved in the removal and consequence re installing. A different application technique is required for the two orientations.

After the locator has been applied to the glass surface, adhesive must be applied to the bevel surfaces. In the preferred embodiment of the invention, low viscosity adhesive is used when applying the bevels to a horizontal surface, and medium viscosity adhesive is used when applying the bevels to a vertical surface. A higher viscosity adhesive is used on the vertical surface because the adhesive is more likely to run when applied to a vertical surface. By increasing the adhesive viscosity, this problem can be largely abated. In the preferred embodiment of the invention, adhesive should be applied to the edge of the bevel that will be applied to the glass first (170). When applying the bevels vertically to the glass, this will be the lower edge. Adhesive should then be applied in a manner as to fill the surface of the bevel starting from the lower edge of application and moving towards the opposite side of the bevel. Approximately 70% of the bevel should be covered with adhesive. In the preferred embodiment of the invention, any visible bubbles in the adhesive will be pushed aside by using the nozzle of the adhesive bottle.

The bevel must be applied to the glass surface shortly after the adhesive has been applied. In the preferred embodiment of the invention, the edge of the bevel upon which the adhesive was first applied should be placed upon the glass surface within the confines of the appropriate region of the locator first (180). The bevel should then be lowered slowly upon the glass, the angle that the bevel and the glass piece form gradually decreasing (190). Once the bevel has been lowered onto the glass surface, the bevel should be pressed onto the glass surface. In the preferred embodiment of the invention, the bevel will be pressed onto the glass surface until adhesive has begun to flow out all of its edges (200). In addition, the bevel will be pressed onto the glass surface until all bubbles between the glass and bevel have been forced out of that region (210). The bevel must be kept within the allotted space upon the glass surface (220). If it overlaps the locator surface, it must be moved before it can be properly cured. When applying the bevels in the vertical position, the bevels must be held in place (230). Then the light source may be applied (240). In the horizontal position, the light source may be applied right away (240). In the preferred embodiment of the invention, if possible, the light source will be applied from the backside of the glass (front side for mirrors), the side upon which the bevel is not affixed. If applied from the front, care must be used to not shield the adhesive from the light source with one's fingers. In the preferred embodiment of the invention, the light source will initially be applied for 30 seconds (240). In one embodiment of the present invention, the light source will then be applied for an additional 30 seconds for a second cure (250).

In the preferred embodiment of the invention, any excess adhesive will be removed (245) after each bevel is applied (240). Excess adhesive should be cleaned (245) (prior to the second cure (250)), with a tissue in order to prevent it from becoming fully hardened. The next bevel will then be applied by repeating the process detailed above (260). In the preferred embodiment of the invention, when applying the bevels vertically, the bevels at the bottom of the design will be applied first and the application process will work its way upward. This is to prevent contamination by dripping/running adhesive of the area where the new bevels will be applied.

Once all bevels have been applied and cured the locators must be removed. Vinyl locators may simply be discarded (270). The reusable locators must be carefully cleaned in order to ensure a long service life. In the preferred embodiment of the invention, reusable locators will be cleaned with a mild detergent, water and a delicate scouring pad (280). Use of chemicals may contaminate the locator for later use and have a detrimental impact upon the adhesive. Also, any remaining adhesive should be removed from the glass surface at this time. In the preferred embodiment of the invention, the dried adhesive will be removed by using razor blade or snap knife to scrape any adhesive off from around the bevel (290). Care must be taken to not scratch the glass. A mild detergent and delicate scouring pad may then be used to remove any remaining adhesive (300).

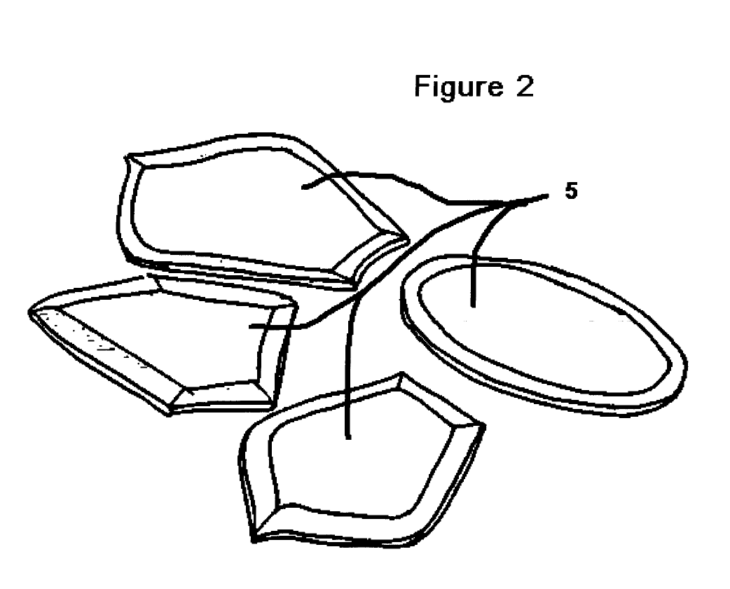

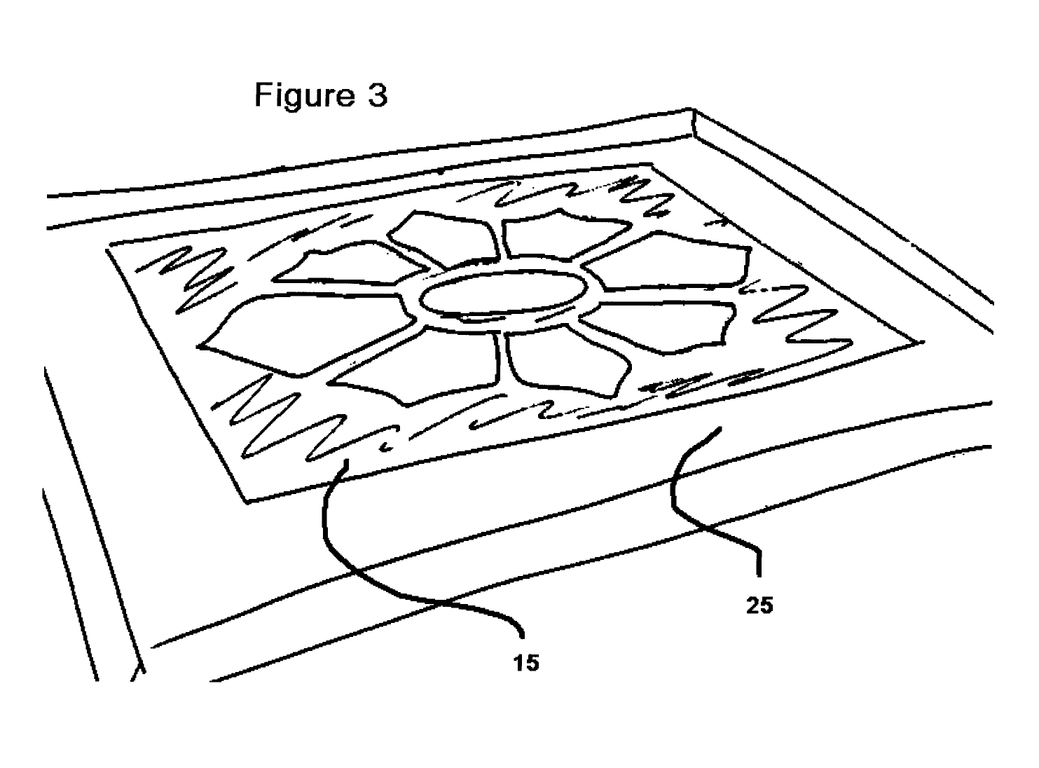

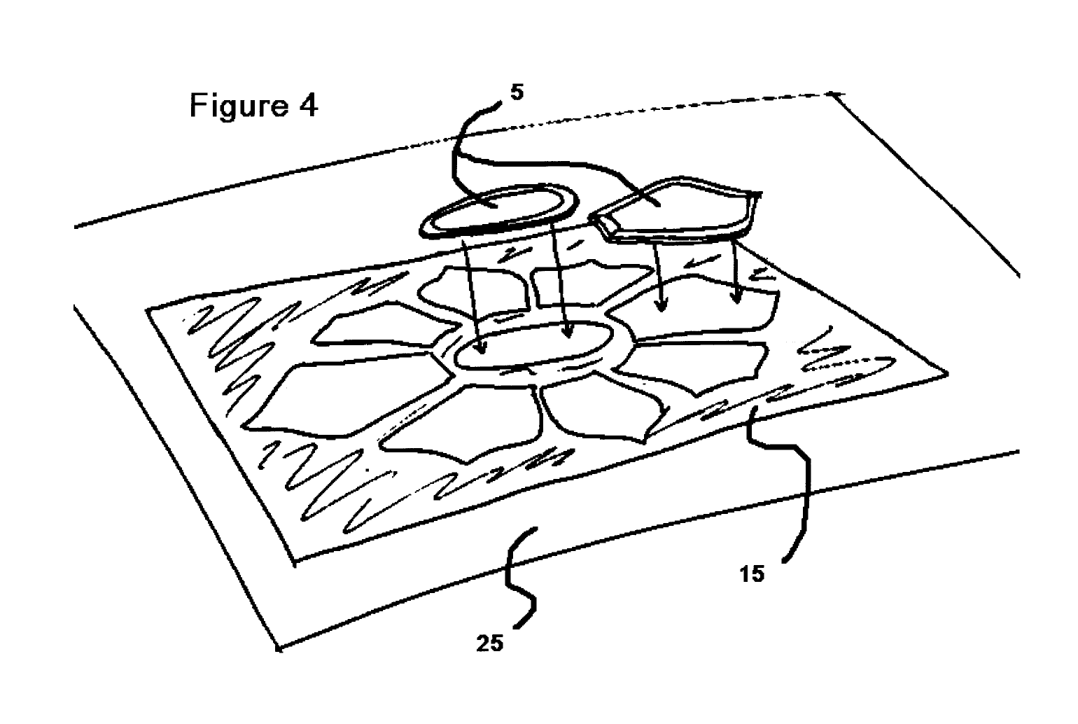

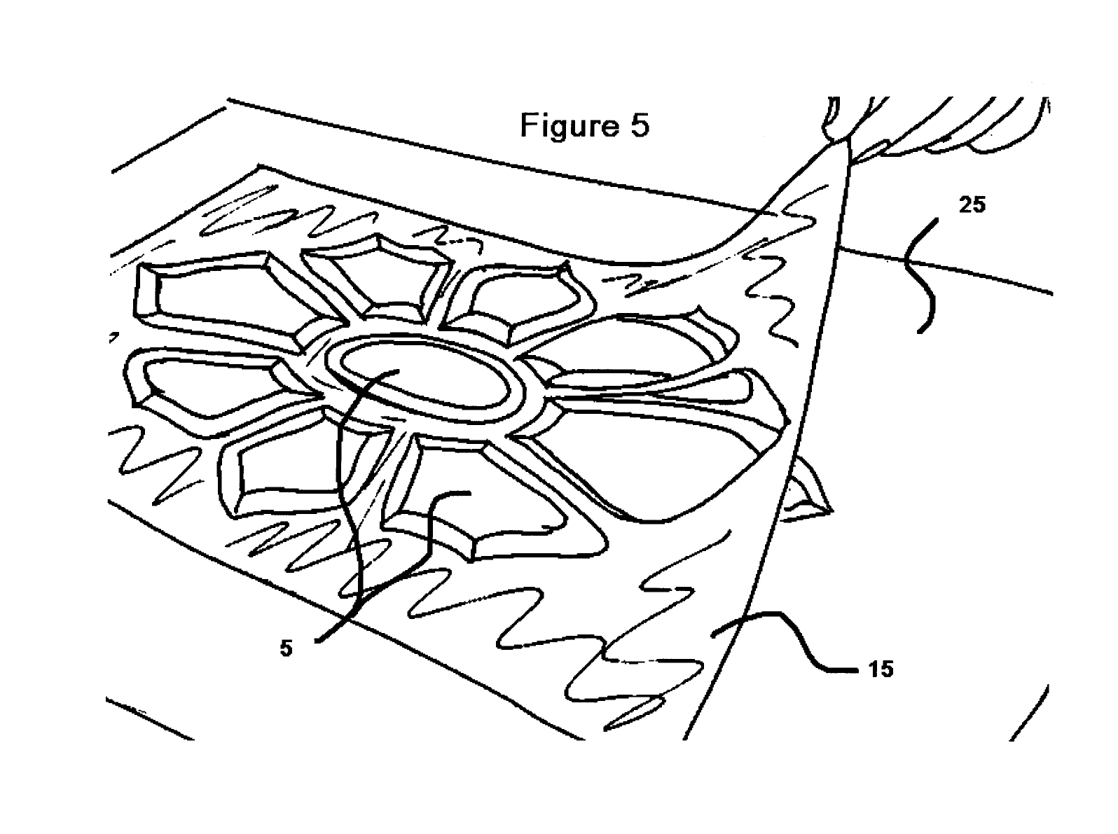

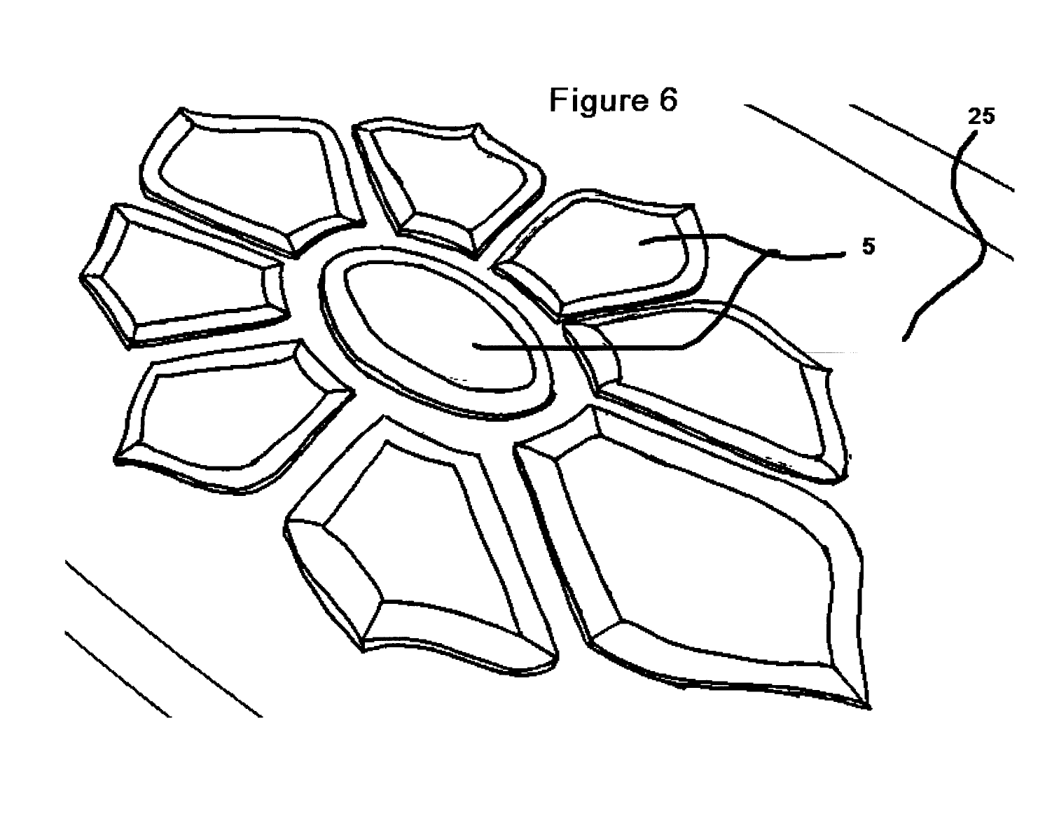

To further understand the present invention, FIGS. 2-6 are provided to actually show the reader the present invention. As shown in FIG. 2, bevels (5) are shown. They are pieces of glass generally five to six mm thick with sloping sides that slope down to a one to two mm thickness. The edges are then polished. As shown in FIG. 3, a locator (15) is placed on a conventional surface (25) prior to placing the bevels (5). As shown in FIG. 4, the bevels (5) are placed within the spaces in the locator (15) on surface (25). As shown in FIG. 5, the locator (15) is lifted from the surface (25) once bevels (5) have been placed. As shown in FIG. 6, the bevels (5) are now in position on surface (25) and the locator (15) has been removed.

It should be understood that the aforementioned description is for illustrative purposes only, and that the present invention should be understood as any and all embodiments within the scope of the following claims.

I claim:

1. A bevel placing process, comprising:
creating bevels;
creating locators; and
applying said bevels using said locators to a mirror or other clear surface.

2. The bevel placing process of claim 1, wherein said bevels are polished on all sides.

3. The bevel placing process of claim 1, wherein said bevels are made of glass.

4. The bevel placing process of claim 1, wherein said locators form decorative patterns into which said bevels are placed.

5. The bevel placing process of claim 1, wherein said locators are reusable.

6. The bevel placing process of claim 1, wherein said locators are made from vinyl.

7. The bevel placing process of claim 1, wherein said bevels are applied with adhesive.

8. The bevel placing process of claim 1, wherein said locators are configured so as to leave uninterrupted space between said bevels so as to allow an uninterrupted view or reflection from said mirror or other clear surface.

9. The bevel placing process of claim 6, wherein said locator has an adhesive backing.

10. The bevel placing process of claim 7, wherein said adhesive is configured to be optically clear when cured.

11. The bevel placing process of claim 7, wherein said adhesive is configured to cure upon the application of visible light.

12. A bevel placing process, comprising:
creating polished, glass, beveled structures with a flat bottom surface;
creating a flat locator; and
applying said beveled structures using said locators to a mirror or other clear surface

13. The bevel placing process of claim 12, wherein said locators form decorative patterns into which said bevels are placed.

14. The bevel placing process of claim 12, wherein said locators are reusable.

15. The bevel placing process of claim 12, wherein said locators are made from vinyl.

16. The bevel placing process of claim 12, wherein said bevels are applied with adhesive.

17. The bevel placing process of claim 12, wherein said locators are configured so as to leave uninterrupted space between said bevels so as to allow an uninterrupted view or reflection from said mirror or other clear surface.

18. The bevel placing process of claim 15, wherein said locator has an adhesive backing.

19. The bevel placing process of claim 16, wherein said adhesive is configured to be optically clear when cured.

20. The bevel placing process of claim 16, wherein said adhesive is configured to cure upon the application of light.
